(19) United States
(12) Patent Application Publication
(10) Pub. No.: US 2015/0315508 A1
(43) Pub. Date: Nov. 5, 2015

(54) Disposable chimney charcoal starter, fuel package and method for starting a fire

(71) Applicant: Wai Lin HO, HUNGHOM (HK)

(72) Inventor: Wai Lin HO, HUNGHOM (HK)

(21) Appl. No.: 14/267,903

(22) Filed: May 1, 2014

(51) Int. Cl. C10L 11/08; C10L 11/06; A47J 37/07

(52) U.S. Cl. CPC C10L 11/08; A47J 37/079; C10L 11/06

(57) ABSTRACT

The present invention provides a new means for kindling charcoal beginning from the center, thus it is possible to make a simple disposable chimney charcoal starter at low manufacturing costs. This disposable chimney charcoal starter includes a first chimney for containing loose discrete pieces of solid fuel, at least one ventilation opening on the first chimney, and a second chimney independent of the first chimney for deferring the burning off of the first chimney and for ventilation. The solid fuel could be prepackaged in the chimney charcoal starter to provide a fuel package. In the present invention, the solid fuel surrounding the second chimney serves as a heat insulator for the first chimney to allow sufficient time duration of “Chimney Effect” for all the solid fuel to be kindled before the first chimney is burnt off completely.

### BACKGROUND OF THE INVENTION

The present invention relates to charcoal starters and more particularly pertains to a disposable chimney charcoal starter and a method for starting a fire using the disposable chimney charcoal starter.

A conventional chimney charcoal starter generally comprises a metallic tubular wall welded with a grate and a lifting handle. The tubular wall has openings at the bottom. Charcoal is rested on top of the grate. To start a fire, a user ignites a firestarter (such as paper) positioned underneath the grate. Due to difference in air temperature and thus pressure between the open top and the bottom openings of the chimney charcoal starter, a “chimney effect” is created to pull hot air from the openings at the bottom of the tubular wall of the chimney charcoal starter up through the tubular wall and thus facilitate kindling of the charcoal. In this way, it usually takes less time to kindle all the charcoal in the chimney charcoal starter. Unfortunately, a conventional chimney charcoal starter cannot be made of simple combustible material because the chimney charcoal starter is very hot when working. If the chimney charcoal starter is burnt out too quickly, the loose fuel/charcoal will spread apart and thus the smoldering of charcoal cannot reach burning temperature, and thus leaving charcoal not fully heat up. So far, there is no design of chimney charcoal starter that is made of non-fire resistant material. Chimney charcoal starter also gets very dusty and dirty after each single use, so users are reluctant to handle chimney charcoal starter after use. Accordingly, chimney charcoal starter is not very popular because both of its relative expensive cost and the trouble to handle it after use.

Most designs of disposable charcoal packages are simply a convenient pack of fuel in a container. There are some designs of disposable charcoal packages, such as U.S. Pat. No. 2,834,661, U.S. Pat. No. 4,953,533, U.S. Pat. No. 7,670,392 and U.S. Pat. No. 7,789,919, which carry a chimney, but all these chimneys provide little “Chimney Effect”. The designs of disposable charcoal package generally comprise an outer container with a base, and an inner chimney which is disposed at the centre of the base of the outer container. Charcoal is placed in the area between the outer container and the inner chimney. Ventilation means is provided at the outer container to feed fresh air from the environment to the bottom of the inner chimney. To start a fire, a user ignites a firestarter positioned at the bottom of the inner chimney. “Chimney Effect” only exists before the outer container is burned away. For the prior designs, there is no much consideration to retard the outer container from burning away. Because a regular outer container, unless with added thickness, is not strong enough to sustain from destruction by fire, the “Chimney Effect” created by these designs are far from sufficient to kindle all the charcoal.

Examples of such disposable charcoal packages are as follows: U.S. Pat. No. 2,834,661 discloses a self-kindling fuel package comprising a container having spaced outer and inner wall means joined at their ends around their peripheries, wherein the inner wall means forms a chimney within the outer wall means with the loose pieces of fuel positioned around the chimney between the outer and inner wall means. This design is not effective as the whole structure will burn off soon. U.S. Pat. No. 3,031,277 discloses a fuel package which makes use of a flue insert device to assist the combustion of the fuel. This design is not cost effective as too many packing material is used for each package. This design also has no measures to retard the ignition of the outer container and thus the whole structure will burn off soon. U.S. Pat. No. 3,374,071 discloses a kindling device for igniting solid fuel comprising the combination of a combustible container member for containing the solid fuel and a metal foil chimney for enclosing the container member. This design is less preferable as it uses some non-combustible material. U.S. Pat. No. 4,460,377 discloses a combustible pack in which the fuel is placed in an upper compartment of the container and the igniting means is disposed in a lower compartment of the container, and a flue means is disposed in the container extending from the lower compartment through the upper compartment; however, there is no measure to retard the ignition of the outer container and again the whole structure will burn off soon. U.S. Pat. No. 4,832,703 discloses a fuel package including a combustible container with open slots in the bottom, and igniting of firestarter through a wick on the surface of the fuel. In this design, charcoal in the container burns from the center, but this is possible only because the firestarter is made of a special mixture of sodium nitrate which releases oxygen when burning; otherwise, there would hardly be sufficient oxygen for the firestarter to burn as the firestarter is buried in the center of the container and limited air could be supplied for the burning of the firestarter. U.S. Pat. No. 4,953,353 discloses a combustible package consisting of a container with a centrally located chimney, wherein the outer wall of the container is configured to form a peripheral air space. It emphasizes the uniform heating and air flow ventilation by means of air spaces around the structure, without much consideration nor utilizing the benefit of the “Chimney Effect”. U.S. Pat. No. 7,670,392 discloses a charcoal based heat source including an inner chimney and an outer container, wherein the bottom wall of the outer container secures to the inner chimney. It is designed to use the inner chimney for receiving air only but not for exhausting the combustion fumes. U.S. Pat. No. 7,789,919 discloses a combustible package including a cardboard outer wall and a bottom lid which is connected to a firestarter; the firestarter forms an inner chimney when ignition starts. It is not effective because there is no measure to retard the ignition of the outer container and thus the whole structure will burn off soon.

Such conventional disposable charcoal packages are all made of combustible material so that they are for single use only. In most of the aforementioned prior charcoal packages, the bottom of the inner chimney is connected to the bottom or the base of the outer container. When the bottom of the inner chimney is ignited, the ignition quickly spreads to the outer container and the outer container soon burns off completely before a majority portion of the charcoal is lit. The charcoal then spreads out on the grill and could no longer benefit from the “Chimney Effect” to get kindled. To lengthen the time for the outer container to burn off completely, the outer container has to be made of a relatively thick combustible material so that it is more difficult to burn. The costs for such thick combustible material are significant in view of the relatively cheap costs of charcoal. It is therefore economically unjustifiable to use the relatively thick combustible material to manufacture the disposable charcoal package for ignition with the benefit of the “Chimney Effect”.

### BRIEF SUMMARY OF THE INVENTION

In view of the aforesaid disadvantages now present in the prior art, the present invention provides a new means for kindling charcoal which utilizes a dual chimney structure and the kindling of the charcoal begins from the center instead of normally from the bottom.

To attain this, the disposable chimney charcoal starter of the present invention generally comprises

a first chimney which is used for containing loose discrete pieces of solid fuel;

at least one ventilation opening provided at a lower side portion of the first chimney;

a second chimney independent of the first chimney and having a top end, a bottom end and a side surface, whereas when in use the second chimney is positioned vertically in the solid fuel so that the bottom end of the second chimney is at a distance from a bottom of the first chimney with the solid fuel insulating the bottom end and the side surface of the second chimney from the first chimney and leaving the top end of the second chimney uncovered by the solid fuel; the second chimney defers the burning off of the first chimney and also serves both as a firestarter and a ventilation means when it burns;

wherein the first chimney and the second chimney are made of combustible material.

The bottom end of the second chimney is preferably positioned approximately at center of the solid fuel when in use.

The second chimney is positioned approximately along a vertical central axis of the first chimney when in use.

The second chimney may be provided with a plurality of through-holes on a lower half part of the side surface thereof.

Preferably, the bottom end of the second chimney and the ventilation opening(s) are at substantially same horizontal level when in use.

In one embodiment, the solid fuel is prepackaged in the first chimney. The solid fuel may be in form of lump charcoal or charcoal briquettes.

In one embodiment, the first chimney has a cross-section of a square, and four ventilation openings are provided on four side walls of the first chimney respectively.

The second chimney may optionally be impregnated with an accelerant. The accelerant may comprise a paraffin wax, a vegetable oil-based wax or the like.

Alternatively, the second chimney may further comprise a firestarter attached to a bottom thereof.

The present invention further provides a fuel package which comprises:

a first chimney with at least one ventilation opening provided at a lower side portion of the first chimney;

loose discrete pieces of solid fuel disposed within the first chimney;

a second chimney independent of the first chimney and having a top end, a bottom end and a side surface, and the second chimney is positioned vertically in the solid fuel so that the bottom end of the second chimney is at a distance from bottom of the first chimney with the solid fuel insulating the bottom end and the side surface of the second chimney from the first chimney and leaving the top end of the second chimney uncovered by the solid fuel; the second chimney defers the burning off of the first chimney and also serves both as a firestarter and a ventilation means when it burns;

wherein the first chimney and the second chimney are made of combustible material.

The bottom end of the second chimney is preferably positioned approximately at center of the solid fuel.

Preferably, the second chimney is positioned approximately along a vertical central axis of the first chimney.

Preferably, the second chimney is provided with a plurality of through-holes on a lower half part of the side surface thereof.

Preferably, the bottom end of the second chimney and the ventilation opening(s) are at substantially same horizontal level when in use.

The second chimney may optionally be impregnated with an accelerant. The accelerant may comprise a paraffin wax, a vegetable oil-based wax or the like.

The solid fuel may be in form of lump charcoal or charcoal briquettes.

In one embodiment, the first chimney has a cross-section of a square, and four ventilation openings are provided on four side walls of the first chimney respectively.

In one embodiment, the second chimney may further comprise a firestarter attached to a bottom thereof.

The present invention further provides a method for starting a fire which comprises the following steps:

(1) selecting a disposable chimney charcoal starter as described above;

(2) positioning loose discrete pieces of solid fuel into the first chimney;

(3) positioning the second chimney vertically in the solid fuel so that the bottom end of the second chimney is at a distance from bottom of the first chimney with the solid fuel insulating the bottom end and the side surface of the second chimney from the first chimney and leaving the top end of the second chimney uncovered by the solid fuel; and

(4) igniting a lower portion of the second chimney and thereby kindling the solid fuel.

In comparison with the prior art, the present invention is characterized in the provision of a new means for kindling charcoal by a dual chimney structure and by kindling begins from the center instead of normally from the bottom. To achieve this, apart from the first chimney which provides a “First Chimney Effect” to entirely light the fuel, a unique second chimney disposed inside the first chimney is equipped to provide a “Second Chimney Effect” for the following multiple purposes: (1) deferring the first chimney from reaching its ignition temperature and thus from burning off because heat energy is drawn inwardly and expel through the second chimney which is located centrally; (2) providing combustion air for the firestarter (i.e. the second chimney itself or the firestarter attached to the bottom of the second chimney) which is positioned in the center of the solid fuel and thus kindling of the solid fuel beginning from the center is possible; (3) providing ventilation to accelerate the complete and efficient combustion of the firestarter and the solid fuel. Because this design is equipped with a second chimney to draw heat energy inwardly; together with the solid fuel surrounding the second chimney which serves as a heat insulator for the first chimney, there is no need for the first chimney to be made of a combustible material which is particularly thick, and thus expensive, so as to allow sufficient time for all the solid fuel to be kindled before the first chimney is burnt off completely. The result is a disposable chimney charcoal starter of simple structure and low manufacturing costs to provide effective kindling of charcoal with dual “Chimney Effect” and beginning in the center of a charge of fuel.

When the present invention is in use, the user places, from the open top, a lighted match inside the second chimney to ignite either a lower portion of the second chimney or a firestarter positioned at the bottom of the second chimney, resulting in combustion of the second chimney from bottom to top and thereby kindling of the solid fuel immediately contacting the second chimney outwardly towards the first chimney. The combustion of the second chimney or the firestarter is possible because combustion air is drawn from the ventilation opening, while combustion fumes is exhausted through the second chimney to the open top. With the solid fuel serving as a heat insulator to the first chimney and thus the first chimney will not burn away instantly, thus there is a “First Chimney Effect” which facilitates kindling of the solid fuel. Even if the second chimney is burnt off completely before all the solid fuel is kindled, yet as the first chimney has still not yet burnt off and thus substantially keeps the solid fuel in place, under normal circumstances there would not be substantial displacement of the solid fuel inside the first chimney to occupy the space left behind by the second chimney. As a result, “Second Chimney Effect” still exists and heat energy is still drawn inwardly and is expelled through the space left behind by the second chimney, which in effect defers the burning off of the first chimney. Additionally, “First Chimney Effect” still exists as the first chimney still has not yet burnt off and the solid fuel inside the first chimney therefore still benefits from the “Dual Chimney Effect” to get kindled. By the time when the heat generated by the kindling of the solid fuel causes the first chimney to burn off, the solid fuel is already kindled entirely.

As a non-limiting example, the first chimney is approximately 25 cm in height, 15 cm in length and 15 cm in width, made of cardboard paper with a density of approximately 400 g/m², and configured to hold 2 kg of charcoal briquettes. There are four ventilation openings, each of which is in shape of a horizontal rectangle with a dimension of 4 cm×3 cm, the lower edge of which is positioned 4 cm from the bottom edge of the side wall of the first chimney. The second chimney is in form of a wound paper tube which is approximately 20 cm in height and 4 cm in diameter with a density of approximately 800 g/m², and is positioned approximately 3-5 cm from the bottom of the first chimney. The second chimney takes about 10 minutes to burn off completely, and the first chimney takes about 20 minutes to burn off completely. By the time when the first chimney is burnt off completely, the charcoal briquettes inside the first chimney are completely kindled and ready for use.

### BRIEF DESCRIPTION OF THE DRAWINGS

FIG. 1 shows a perspective view of the first chimney of an embodiment of the chimney charcoal starter of the present invention.

FIG. 2 shows a perspective view of the second chimney of an embodiment of the chimney charcoal starter of the present invention.

FIG. 3 illustrates the position of the second chimney of an embodiment of the chimney charcoal starter of the present invention when in use.

FIG. 4 illustrates another embodiment of the chimney charcoal starter of the present invention.

FIG. 5 illustrates yet another embodiment of the chimney charcoal starter of the present invention.

### DETAILED DESCRIPTION OF THE INVENTION

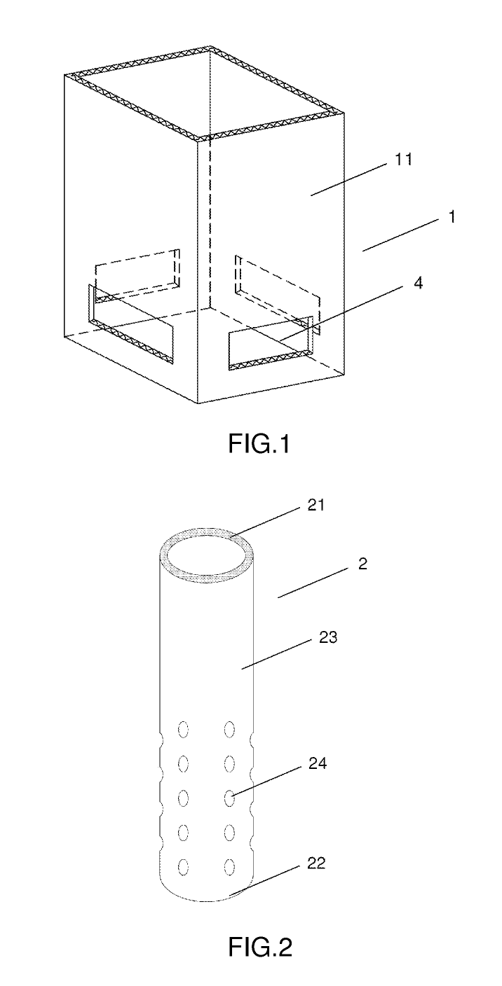

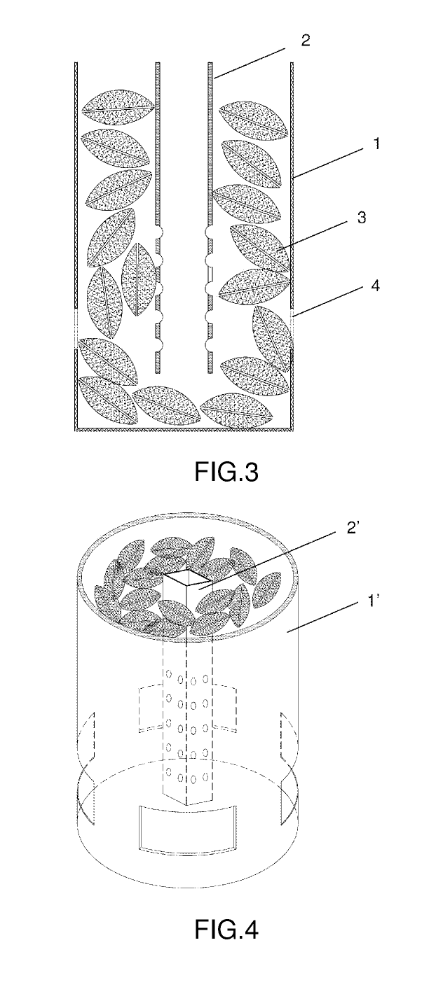

As illustrated in FIGS. 1-3, a preferred embodiment of the disposable chimney charcoal starter of the present invention comprises a first chimney 1 made of cardboard paper, and a second chimney 2 in form of a wound paper tube. The first chimney 1 is used for containing loose discrete pieces of solid fuel 3. In this embodiment, the first chimney 1 has a cross-section of a square, and four ventilation openings 4 are provided on four side walls 11 of the first chimney 1 respectively. The second chimney 2 is independent of the first chimney 1 and has a top end 21, a bottom end 22 and a side surface 23. The second chimney 2 in this embodiment is provided with a plurality of through-holes 24 on the lower half part of the side surface 23, but in other embodiments the second chimney 2 may have no through-holes on the side surface 23. The second chimney 2 in this embodiment is not impregnated with any accelerant, but in other embodiments the second chimney 2 may be impregnated with accelerants such as paraffin wax. It could be envisaged that the solid fuel 3 in form of lump charcoal or charcoal briquettes may be filled into the first chimney 1 by the user before use, or prepackaged in the first chimney 1 and sold as an integral fuel package. In the latter case, the second chimney 2 is positioned vertically in the solid fuel 3.

In this embodiment, the first chimney 1 is approximately 25 cm in height, 15 cm in length and 15 cm in width, made of cardboard paper with a density of approximately 400 g/m², and configured to hold 2 kg of charcoal briquettes. The four ventilation openings 4 are each in shape of a horizontal rectangle with a dimension of 4 cm×3 cm, the lower edge of which is positioned 4 cm from the bottom edge of the side wall 11 of the first chimney 1. The second chimney 2 is approximately 20 cm in height and 4 cm in diameter with a density of approximately 800 g/m². It should be understood that different dimensions and configurations are also possible in other embodiments.

To use the present invention, if the solid fuel 3 has not been prepackaged in the first chimney 1, the user needs to first fill the first chimney 1 with solid fuel; then, the user positions the second chimney 2 vertically in the solid fuel 3, preferably approximately along a vertical central axis of the first chimney 1, so that the bottom end 22 of the second chimney 2 is at a distance from bottom of the first chimney 1 with the solid fuel 3 insulating the bottom end 22 and the side surface 23 of the second chimney 2 from the first chimney 1 and leaving the top end 21 of the second chimney 2 uncovered by the solid fuel 3. Preferably, the bottom end 22 of the second chimney 2 and the ventilation openings 4 are at substantially same horizontal level when in use, so that the second chimney 2 is at a distance of approximately 3-5 cm from the bottom of the first chimney 1. More preferably, the bottom end 22 of the second chimney 2 is positioned approximately at center of the solid fuel 3. The user then ignites a lower portion of the second chimney 2 by placing, from the top end of the second chimney 21, a lighted match inside the second chimney 2, resulting in combustion of the second chimney 2 from bottom to top and thereby kindling of the solid fuel 3 immediately contacting the second chimney 2 outwardly towards the first chimney 1. The combustion of the second chimney 2 is possible because combustion air is drawn from the ventilation openings 4, while combustion fumes is exhausted through the second chimney 2 to the open top 21. With the solid fuel 3 serving as a heat insulator to the first chimney 1 and thus the first chimney 1 will not burn away instantly, thus there is a “First Chimney Effect” which facilitates kindling of the solid fuel 3. Even if the second chimney 2 is burnt off completely before all the solid fuel 3 is kindled, yet as the first chimney 1 has still not yet burnt off and thus substantially keeps the solid fuel 3 in place, under normal circumstances there would not be substantial displacement of the solid fuel 3 inside the first chimney 1 to occupy the space left behind by the second chimney 2. As a result, “Second Chimney Effect” still exists and heat energy is still drawn inwardly and is expelled through the space left behind by the second chimney 2, which in effect defers the burning off of the first chimney 1. Additionally, “First Chimney Effect” still exists as the first chimney 1 still has not yet burnt off and the solid fuel 3 inside the first chimney 1 therefore benefits from the “Dual Chimney Effect” to get kindled. In this embodiment, the second chimney 2 takes about 10 minutes to burn off completely, and the first chimney 1 takes about 20 minutes to burn off completely. By the time when the heat generated by the kindling of the solid fuel 3 causes the first chimney 1 to burn off, the solid fuel 3 is already kindled entirely.

In the case when the solid fuel 3 is prepackaged in the first chimney 1, the user simply uses a lighted match to ignite the lower portion of the second chimney 2 and thereby kindling the solid fuel 3, as described above.

FIG. 4 illustrates another embodiment of the chimney charcoal starter of the present invention, wherein the second chimney 2′ has a cross section of a rectangle and the first chimney 1′ has a cross section of a circle. Other features and operation of this embodiment is substantially the same as the previous embodiment and are therefore not repeated herein.

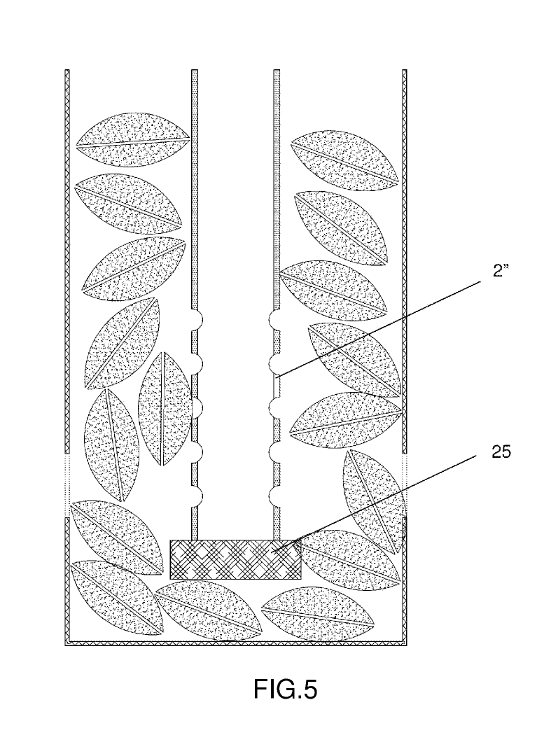

FIG. 5 illustrates yet another embodiment of the chimney charcoal starter of the present invention, wherein the second chimney 2″ further comprises a firestarter 25 attached to a bottom thereof. Other features and operation of this embodiment is substantially the same as the previous embodiment and are therefore not repeated herein.

As to a further discussion of the manner of usage and operation of the present invention, the same should be apparent from the above description. Accordingly, no further discussion relating to the manner of usage and operation is provided.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

What is claimed is:

1. A disposable chimney charcoal starter which comprises:
a first chimney which is used for containing loose discrete pieces of solid fuel;
at least one ventilation opening provided at a lower side portion of the first chimney;
a second chimney independent of the first chimney and having a top end, a bottom end and a side surface, whereas when in use the second chimney is positioned vertically in the solid fuel so that the bottom end of the second chimney is at a distance from bottom of the first chimney with the solid fuel insulating the bottom end and the side surface of the second chimney from the first chimney and leaving the top end of the second chimney uncovered by the solid fuel; the second chimney defers the burning off of the first chimney and also serves both as a firestarter and a ventilation means when it burns;
wherein the first chimney and the second chimney are made of combustible material.

2. The chimney charcoal starter as in claim 1, wherein the bottom end of the second chimney is positioned approximately at center of the solid fuel when in use.

3. The chimney charcoal starter as in claim 1, wherein the second chimney is positioned approximately along a vertical central axis of the first chimney when in use.

4. The chimney charcoal starter as in claim 1, wherein the second chimney is provided with a plurality of through-holes on a lower half part of the side surface thereof.

5. The chimney charcoal starter as in claim 1, wherein the bottom end of the second chimney and the ventilation opening(s) are at substantially same horizontal level when in use.

6. The chimney charcoal starter as in claim 1, wherein the solid fuel is prepackaged in the first chimney.

7. The chimney charcoal starter as in claim 1, wherein the solid fuel is in form of lump charcoal or charcoal briquettes.

8. The chimney charcoal starter as in claim 1, wherein the first chimney has a cross-section of a square, and four ventilation openings are provided on four side walls of the first chimney respectively.

9. The chimney charcoal starter as in claim 1, wherein the second chimney is impregnated with an accelerant; the accelerant may comprise a paraffin wax, a vegetable oil-based wax or the like.

10. The chimney charcoal starter as in claim 1, wherein the second chimney further comprises a firestarter attached to a bottom thereof.

11. A fuel package which comprises a first chimney with at least one ventilation opening provided at a lower side portion of the first chimney;
loose discrete pieces of solid fuel disposed within the first chimney;
a second chimney independent of the first chimney and having a top end, a bottom end and a side surface, and the second chimney is positioned vertically in the solid fuel so that the bottom end of the second chimney is at a distance from bottom of the first chimney with the solid fuel insulating the bottom end and the side surface of the second chimney from the first chimney and leaving the top end of the second chimney uncovered by the solid fuel; the second chimney defers the burning off of the first chimney and also serves both as a firestarter and a ventilation means when it burns;
wherein the first chimney and the second chimney are made of combustible material.

12. The fuel package as in claim 11, wherein the bottom end of the second chimney is positioned approximately at center of the solid fuel.

13. The fuel package as in claim 11, wherein the second chimney is positioned approximately along a vertical central axis of the first chimney.

14. The fuel package as in claim 11, wherein the second chimney is provided with a plurality of through-holes on a lower half part of the side surface thereof.

15. The fuel package as in claim 11, wherein the bottom end of the second chimney and the ventilation opening(s) are at substantially same horizontal level when in use.

16. The fuel package as in claim 11, wherein the solid fuel is in form of lump charcoal or charcoal briquettes.

17. The fuel package as in claim 11, wherein the first chimney has a cross-section of a square, and four ventilation openings are provided on four side walls of the first chimney respectively.

18. The fuel package as in claim 11, wherein the second chimney may optionally be impregnated with an accelerant; the accelerant may comprise a paraffin wax, a vegetable oil-based wax or the like.

19. The fuel package as in claim 11, wherein the second chimney further comprises a firestarter attached to a bottom thereof.

20. A method for starting a fire which comprises the following steps:
(1) selecting a disposable chimney charcoal starter which comprises:
a first chimney which is used for containing loose discrete pieces of solid fuel;
at least one ventilation opening provided at a lower side portion of the first chimney;
a second chimney independent of the first chimney and having a top end, a bottom end and a side surface, whereas when in use the second chimney is positioned vertically in the solid fuel so that the bottom end of the second chimney is at a distance from bottom of the first chimney with the solid fuel insulating the bottom end and the side surface of the second chimney from the first chimney and leaving the top end of the second chimney uncovered by the solid fuel; the second chimney defers the burning off of the first chimney and also serves both as a firestarter and a ventilation means when it burns;
wherein the first chimney and the second chimney are made of combustible material;
(2) positioning loose discrete pieces of solid fuel into the first chimney;
(3) positioning the second chimney to a position vertically in the solid fuel so that the bottom end of the second chimney is at a distance from bottom of the first chimney with the solid fuel insulating the bottom end and the side surface of the second chimney from the first chimney and leaving the top end of the second chimney uncovered by the solid fuel; and
(4) igniting a lower portion of the second chimney and thereby kindling the solid fuel.
